(19) United States
(12) Patent Application Publication
(10) Pub. No.: US 2026/0210256 A1
(43) Pub. Date: Jul. 23, 2026

(54) WAVY-EDGED FLANGE FOR GAS TURBINE ENGINE DOUBLE ROW STATOR ASSEMBLY

(71) Applicant: PRATT & WHITNEY CANADA CORP., Longueuil (CA)

(72) Inventor: Henri Cardinal-Pilote, Montreal (CA)

(21) Appl. No.: 19/032,887

(22) Filed: Jan. 21, 2025

(51) Int. Cl. F01D 9/04

(52) U.S. Cl. CPC F01D 9/041; F05D 2220/32; F05D 2230/31; F05D 2240/12; F05D 2260/30

(57) ABSTRACT

A double row stator assembly for a gas turbine engine includes a first vane row stator assembly that includes a plurality of first-row vanes, a second vane row stator assembly that includes a plurality of second-row vanes, and a wavy-edged flange configured to secure the first vane row stator assembly to the second vane row stator assembly when the first vane row stator assembly and second vane row stator assembly are assembled to form the double row stator assembly. The second vane row stator assembly is configured to be positioned to be sequentially downstream of the first vane row stator assembly when the first vane row stator assembly and the vane row second stator assembly are assembled to form the double row stator assembly such that trailing edges of the first-row vanes overlap leading edges of the second-row vanes.

### BACKGROUND

The present disclosure relates generally to a gas turbine engine compressor and, more particularly, to a double row gas turbine engine compressor stator assembly.

Gas turbine engines typically include at least a compressor section, a combustor section, and a turbine section. The compressor and turbine sections can include multiple alternating stages of rotating and stationary airfoils to compress air (in the compressor section) and extract energy from hot combustor exhaust gases (in the turbine section). The stationary airfoil stages (sometimes referred to as stators or vanes) are configured to redirect oncoming airflow as desired for engine components downstream of the stationary airfoil stages (e.g., a downstream rotating airfoil stage, the combustor section, or other downstream components.

### SUMMARY

One aspect of this disclosure is directed to a double row stator assembly for a gas turbine engine including a first vane row stator assembly that includes a plurality of first-row vanes, a second vane row stator assembly that includes a plurality of second-row vanes, and a wavy-edged flange configured to secure the first vane row stator assembly to the second vane row stator assembly when the first vane row stator assembly and second vane row stator assembly are assembled to form the double row stator assembly. The second vane row stator assembly is configured to be positioned to be sequentially downstream of the first vane row stator assembly when the first vane row stator assembly and the vane row second stator assembly are assembled to form the double row stator assembly such that trailing edges of the first-row vanes overlap leading edges of the second-row vanes.

Another aspect of the disclosure is directed to a method of making a double row stator assembly for a gas turbine engine that includes integrally forming, using a continuous additive manufacturing (AM) technique, a first vane row stator assembly, a plurality of first-row vanes, a second vane row stator assembly, a plurality of second-row vanes, and a wavy-edged flange. The first vane row stator assembly includes the plurality of first-row vanes. The second vane row stator assembly includes the plurality of second-row vanes such that the second vane row stator assembly is configured to be positioned to be sequentially downstream of the first vane row stator assembly when the first vane row stator assembly and the second vane row stator assembly are assembled to form the double row stator assembly such that trailing edges of the first-row vanes overlap leading edges of the second-row vanes. The wavy-edged flange is configured to secure the first vane row stator assembly to the second vane row stator assembly when the first vane row stator assembly and second vane row stator assembly are assembled to form the double row stator assembly.

### BRIEF DESCRIPTION OF THE DRAWINGS

FIG. 1 is a cross-section view of an exemplary gas turbine engine.

FIG. 2 is an overhead view of a double row stator assembly in a gas turbine engine.

FIG. 3 is an enlarged view of a wavy-edged flange and related seals between individual rows of the double row stator assembly of FIG. 2.

FIG. 4 is another view of the seals of FIG. 3.

### DETAILED DESCRIPTION

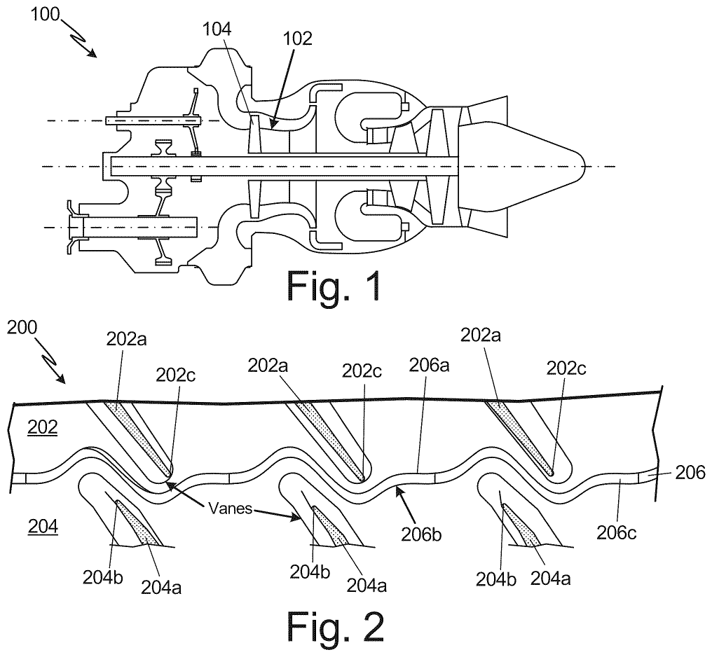

Current gas turbine engines sometimes use a double row stator assembly aerodynamically downstream of low pressure compressor (LPC) and high pressure compressor (HPC) rotors. FIG. 1 shows a cross-section of an exemplary gas turbine engine 100. The arrow 102 points to location of a double row stator assembly (see FIG. 2) in the gas turbine engine 100 downstream of a HPC rotor 104. Although the disclosed double row stator assembly is discussed in the context of a gas turbine engine compressor section, as person skilled in the art will recognize that the double row stator assembly can be equally applicable to a gas turbine engine turbine section.

As shown in FIG. 2, a double row stator assembly 200 can pose manufacturing challenges as the adjoining, sequential vane row stator assemblies 202, 204 are very close to each other, the space between the vanes 202a, 202b is limited, and the vane geometry is complex due to aerodynamic and structural design considerations. As a result, the manufacturing process can be complex and time consuming as it can require machining for all the vanes, the vane inner and outer shrouds, and custom fixtures for assembly, welding, and brazing. The complexity of the double row stator assembly 200 can make it a pacer item in gas turbine engine builds. In addition, the complex manufacturing process can limit design flexibility for double row stator assembly 200 designs. In some examples, using an additive manufacturing (AM) technique instead of subtractive manufacturing techniques (e.g., machining) does not address the complexity of manufacturing a double row stator assembly because of the challenge of support material used in AM techniques getting stuck between the vane row stator assemblies 202, 204. The AM technique can be any AM technique known to be useful for making gas turbine engine components including, without limitation, laser beam powder bed fusion, electron beam powder bed fusion, laser powder directed energy deposition, electron beam wire directed energy deposition, arc wire directed energy deposition, cold spray, binder jetting, and metal extrusion.

Looking at FIG. 2 in more detail, a double row stator assembly 200 can be designed as two adjoining sequential single row stator assemblies, a first single row stator assembly 202 and a second single row stator assembly 204 that can be separately manufactured using AM techniques and assembled to form the desired double row stator assembly 200. A person skilled in the art will recognize that other components of the gas turbine engine 100 can also be manufactured using AM techniques. Each of the first single row stator assembly 202 and a second single row stator assembly 204 include a plurality of airfoils 202a, 204a (also known as vanes), each of which has a leading edge 204b (the first-row vane 202a leading edge is not visible in FIG. 2) and a trailing edge 202c (the second-row vane 204a trailing edge is not visible in FIG. 2). As depicted in FIG. 2, the first-row vane 202a trailing edges 202c can overlap with the second-row vane 204a leading edges 204b. The overlap of the first-row vane 202a trailing edges 202c with the second-row vane 204a leading edges 204b can make it impractical or impossible to have a straight flange line between the first single row stator assembly 202 and the second single row stator assembly 204.

As further shown in FIG. 2, the splitting of the double row stator assembly 200 into two vane row stator assemblies 202, 204 can be done with a wavy-edged flange 206 having a first flange side 206a and a second flange side 206b formed as part of the first stator assembly 202 and the second stator assembly 204, respectively. The wavy-edged flange 206 is configured to secure the first stator assembly 202 to the second stator assembly 204 when the first stator assembly and second stator assembly are assembled to form the double row stator assembly 200. The cross-section through the stator vanes 202a, 204a near their respective outer shrouds 202d, 204d shows a wavy-edged flange 206c gap going around the vanes 202a, 204a of both single row stator assemblies 202, 204.

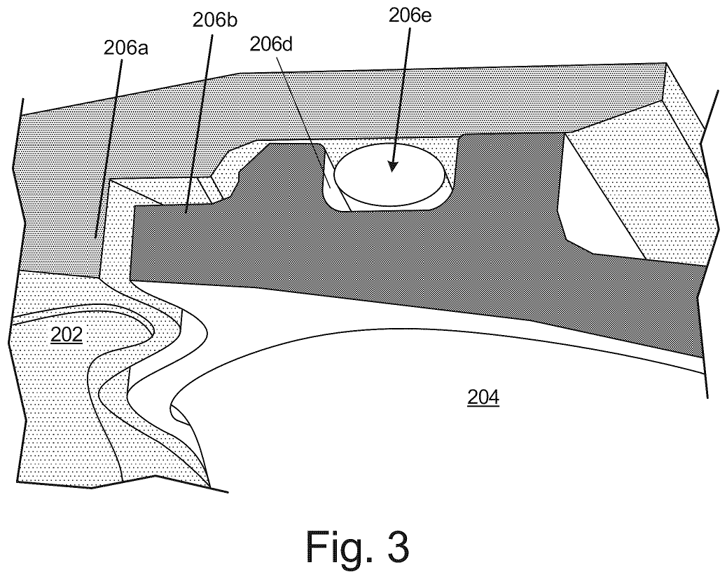

For purposes of this application, the term “wavy-edged” can be defined by one or more of the following concepts: a curvilinear edge (i.e., an edge formed by curved lines), an undulating edge (i.e., a smooth, wave-like edge that rises and falls in a regular pattern), or a sinusoidal edge (i.e., an edge derived from a sine wave having a smooth, periodic oscillation) for a “wavy edge” that follows a regular, repeating pattern or an amorphic edge (i.e., an edge formed by an pattern that does not follow a regular, repeating pattern) for a “wavy edge” that follows an irregular pattern. In either case, the first and second flange sides 206a, 206b of the wavy-edged flange 206 are configured to fit together to form a tight seal when assembled as discussed below with reference to FIG. 3. The wavy flange gap 206c is sized to accommodate thermal growth when the first and second flange sides 206a, 206b of the wavy-edged flange 206 are assembled and the gas turbine engine 100 is in operation.

FIG. 3 shows the double row stator assembly 200 design provides structural support for the stator vanes 202a, 204a of each of the two single row stator assemblies 202, 204, which is important for stress and vibration considerations. As discussed, the wavy flange gap 206c facilitates assembly of the double row stator assembly 200 and accommodates thermal growth when the gas turbine engine 100 is in operation. To create a gas path seal, the wavy flange 206 can include a packing channel 206d in the second flange side 206b (i.e., the portion of the wavy flange 206 associated with the second-row stator assembly 204) and packing body 206e positioned in the packing channel 206d. The packing channel 206d and packing body 206e can be sized to provide a gas-tight seal between the first flange side 206a and second flange side 206b. As shown in FIG. 3, in one example, the first flange side 206a can be configured to overlap the second flange size 206b. In other examples, the relative positioning of the first flange side 206a to the second flange side 206b and the location of the packing channel 206d and packing body 206e can be any relative positioning deemed appropriate for a particular application provided that the selected relative positioning provides diametral tight fit such that both stator stages 202, 204 are concentric once assembled to form the double row stator assembly 200. The packing body 206e can be formed in any appropriate shape and made from any appropriate material to provide a gas-tight seal that is compatible with the gas turbine operating conditions to which it will be exposed. For example, the packing body 206e can be formed as an elastomeric o-ring having an oval cross-section as shown in FIG. 3 or shape and material deemed appropriate for a particular application.

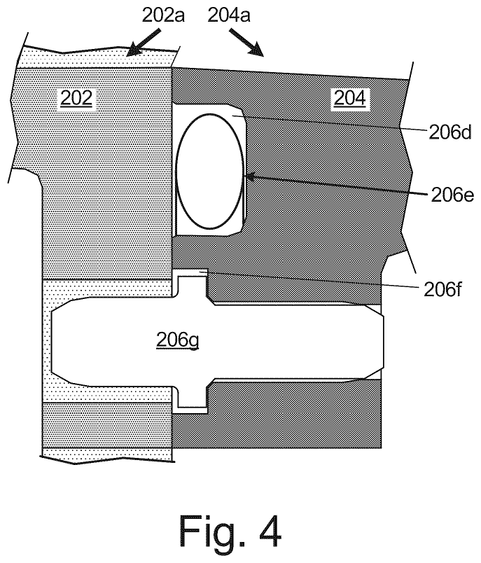

As shown in FIG. 4, the packing channel 206d and packing body 206e can be supplemented with a dowel pin 206g positioned in a dowel pin channel 206f to secure a joint between the stator stages 202, 204. The combination of the packing channel 206d/packing body 206e and the dowel pin channel 206f/dowel pin 206g facilitate the desired axial and radial (i.e., clocking) alignment of both stator stages 202, 204.

The disclosed wavy-edge flange design allows the design of the double row stator assembly 200 to be aerodynamically optimized such that the vanes 202a, 204a of both stator stages 202, 204 can be positioned close to each other without any inherent limitation of vane 202a, 204a airfoil geometry and quantity per row other than ordinary structural consideration (e.g., stress, vibration, etc.). Although the disclosed wavy-edge flange design is discussed in the context of a gas turbine engine compressor section, as person skilled in the art will recognize that the wavy-edge flange design can be equally applicable to a gas turbine engine turbine section. Further, the wavy-edged flange design coupled with AM techniques is relatively inexpensive and quick to manufacture, making it excellent for experimental engine testing. For a production engine, the wavy-edged flange design provides an opportunity to decrease the replacement cost during overhauls, as potentially only one of the stator stages 202, 204 of a double row stator assembly 200 would need to be replaced to address a single broken stator vane 202a, 204a.

### Discussion of Possible Embodiments

The following are non-exclusive descriptions of possible embodiments of the present invention.

A double row stator assembly for a gas turbine engine includes a first vane row stator assembly that includes a plurality of first-row vanes, a second vane row stator assembly that includes a plurality of second-row vanes, and a wavy-edged flange configured to secure the first vane row stator assembly to the second vane row stator assembly when the first vane row stator assembly and second vane row stator assembly are assembled to form the double row stator assembly. The second vane row stator assembly is configured to be positioned to be sequentially downstream of the first vane row stator assembly when the first vane row stator assembly and the vane row second stator assembly are assembled to form the double row stator assembly such that the trailing edges of the first-row vanes overlap the leading edges of the second-row vanes.

The double row stator assembly of the preceding paragraph can optionally include, additionally and/or alternatively, any one or more of the following features, configurations and/or additional elements:

The wavy-edged flange includes a first flange side formed as part of the first vane row stator assembly and a second flange side formed as part of the second vane row stator assembly.

The wavy-edged flange further includes a wavy-edged flange gap positioned between the first flange side and the second flange side, wherein the wavy-edged flange gap is sized to accommodate thermal growth when the double row stator assembly is assembled and the gas turbine engine is in operation.

The wavy-edged flange further includes a packing channel and a packing body disposed in the packing channel.

The packing body comprises a o-ring made from an elastomeric material.

The first flange side is configured to overlap the second flange side to form a gas-tight seal between the first vane row stator assembly and the second vane row stator assembly in combination with the packing channel and packing body.

Further comprising a dowel pin positioned in a dowel pin channel, wherein the dowel pin and dowel pin channel are configured to secure a joint between the first vane row stator assembly and second vane row stator assembly and facilitate axial and radial alignment between the first vane row stator assembly and second vane row stator assembly when the double row stator assembly is assembled.

The a first vane row stator assembly, the plurality of first-row vanes, the second vane row stator assembly, the second-row vanes, and the a wavy-edged flange are made with an additive manufacturing (AM) technique.

The AM technique is one of electron beam powder bed fusion, laser powder directed energy deposition, electron beam wire directed energy deposition, arc wire directed energy deposition, cold spray, binder jetting, and metal extrusion.

A method of making a double row stator assembly for a gas turbine engine includes integrally forming, using a continuous additive manufacturing (AM) technique, a first vane row stator assembly, a plurality of first-row vanes, a second vane row stator assembly, a plurality of second-row vanes, and a wavy-edged flange. The first vane row stator assembly includes the plurality of first-row vanes. The second vane row stator assembly includes the plurality of second-row vanes such that the second vane row stator assembly is configured to be positioned to be sequentially downstream of the first vane row stator assembly when the first vane row stator assembly and the second vane row stator assembly are assembled to form the double row stator assembly such that trailing edges of the first-row vanes overlap leading edges of the second-row vanes. The wavy-edged flange is configured to secure the first vane row stator assembly to the second vane row stator assembly when the first vane row stator assembly and second vane row stator assembly are assembled to form the double row stator assembly.

The method of the preceding paragraph can optionally include, additionally and/or alternatively, any one or more of the following features, configurations and/or additional elements:

The wavy-edged flange includes a first flange side formed as part of the first vane row stator assembly and a second flange side formed as part of the second vane row stator assembly.

The wavy-edged flange further includes a wavy-edged flange gap positioned between the first flange side and the second flange side, wherein the wavy-edged flange gap is sized to accommodate thermal growth when the double row stator assembly is assembled and the gas turbine engine is in operation.

The wavy-edged flange further includes a packing channel and a packing body disposed in the packing channel.

The packing body comprises an o-ring made from an elastomeric material.

The first flange side is configured to overlap the second flange side to form a gas-tight seal between the first vane row stator assembly and the second vane row stator assembly in combination with the packing channel and packing body.

Further comprising a dowel pin positioned in a dowel pin channel, wherein the dowel pin and dowel pin channel are configured to secure a joint between the first vane row stator assembly and second vane row stator assembly and facilitate axial and radial alignment between the first vane row stator assembly and second vane row stator assembly when the double row stator assembly is assembled.

The first vane row stator assembly, the plurality of first-row vanes, the second vane row stator assembly, the second-row vanes, and the a wavy-edged flange are made with an additive manufacturing (AM) technique.

The AM technique is one of electron beam powder bed fusion, laser powder directed energy deposition, electron beam wire directed energy deposition, arc wire directed energy deposition, cold spray, binder jetting, and metal extrusion.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment(s) disclosed, but that the invention will include all embodiments falling within the scope of the appended claims.

1. A double row stator assembly for a gas turbine engine comprising:
a first vane row stator assembly that includes a plurality of first-row vanes;
a second vane row stator assembly that includes a plurality of second-row vanes,
wherein the second vane row stator assembly is configured to be positioned to be sequentially downstream of the first vane row stator assembly when the first vane row stator assembly and the vane row second stator assembly are assembled to form the double row stator assembly such that trailing edges of the first-row vanes overlap leading edges of the second-row vanes; and
a wavy-edged flange configured to secure the first vane row stator assembly to the second vane row stator assembly when the first vane row stator assembly and second vane row stator assembly are assembled to form the double row stator assembly.

2. The double row stator assembly of claim 1, wherein the wavy-edged flange includes a first flange side formed as part of the first vane row stator assembly and a second flange side formed as part of the second vane row stator assembly.

3. The double row stator assembly of claim 2, wherein the wavy-edged flange further includes a wavy-edged flange gap positioned between the first flange side and the second flange side, wherein the wavy-edged flange gap is sized to accommodate thermal growth when the double row stator assembly is assembled and the gas turbine engine is in operation.

4. The double row stator assembly of claim 3, wherein the wavy-edged flange further includes a packing channel and a packing body disposed in the packing channel.

5. The double row stator assembly of claim 4 wherein the packing body comprises an o-ring made from an elastomeric material.

6. The double row stator assembly of claim 3, wherein the first flange side is configured to overlap the second flange side to form a gas-tight seal between the first vane row stator assembly and the second vane row stator assembly in combination with the packing channel and packing body.

7. The double row stator assembly of claim 3, further comprising a dowel pin positioned in a dowel pin channel, wherein the dowel pin and dowel pin channel are configured to secure a joint between the first vane row stator assembly and second vane row stator assembly and facilitate axial and radial alignment between the first vane row stator assembly and second vane row stator assembly when the double row stator assembly is assembled.

8. The double row stator assembly of claim 1, wherein the a first vane row stator assembly, the plurality of first-row vanes, the second vane row stator assembly, the second-row vanes, and the a wavy-edged flange are made with an additive manufacturing (AM) technique.

9. The double row stator assembly of claim 8, wherein the AM technique is one of electron beam powder bed fusion, laser powder directed energy deposition, electron beam wire directed energy deposition, arc wire directed energy deposition, cold spray, binder jetting, and metal extrusion.

10. A method of making a double row stator assembly for a gas turbine engine comprising:
integrally forming, using a continuous additive manufacturing (AM) technique, a first vane row stator assembly, a plurality of first-row vanes, a second vane row stator assembly, a plurality of second-row vanes, and a wavy-edged flange; wherein
the first vane row stator assembly includes the plurality of first-row vanes;
the second vane row stator assembly includes the plurality of second-row vanes,
wherein the second vane row stator assembly is configured to be positioned to be sequentially downstream of the first vane row stator assembly when the first vane row stator assembly and the second vane row stator assembly are assembled to form the double row stator assembly such that trailing edges of the first-row vanes overlap leading edges of the second-row vanes; and
the wavy-edged flange is configured to secure the first vane row stator assembly to the second vane row stator assembly when the first vane row stator assembly and second vane row stator assembly are assembled to form the double row stator assembly.

11. The method of claim 10, wherein the wavy-edged flange includes a first flange side formed as part of the first vane row stator assembly and a second flange side formed as part of the second vane row stator assembly.

12. The method of claim 11, wherein the wavy-edged flange further includes a wavy-edged flange gap positioned between the first flange side and the second flange side, wherein the wavy-edged flange gap is sized to accommodate thermal growth when the double row stator assembly is assembled and the gas turbine engine is in operation.

13. The method of claim 12, wherein the wavy-edged flange further includes a packing channel and a packing body disposed in the packing channel.

14. The method of claim 13, wherein the packing body comprises a o-ring made from an elastomeric material.

15. The method of claim 12, wherein the first flange side is configured to overlap the second flange side to form a gas-tight seal in combination with the packing channel and packing body.

16. The method of claim 12, further comprising a dowel pin positioned in a dowel pin channel, wherein the dowel pin and dowel pin channel are configured to secure a joint between the first vane row stator assembly and second vane row stator assembly and facilitate axial and radial alignment between the first vane row stator assembly and second vane row stator assembly when the double row stator assembly is assembled.

17. The method of claim 10, wherein the AM technique is one of electron beam powder bed fusion, laser powder directed energy deposition, electron beam wire directed energy deposition, arc wire directed energy deposition, cold spray, binder jetting, and metal extrusion.
